(19) United States
(12) Patent Application Publication
(10) Pub. No.: US 2026/0175451 A1
(43) Pub. Date: Jun. 25, 2026

(54) ROBOTIC GRIPPER APPARATUS FOR COUPLING TO VEHICLE COMPONENT

(71) Applicant: Ford Global Technologies, LLC, Dearborn, MI (US)

(72) Inventors: Kurt Michael Lundeen, Novi, MI (US); Jon Arthur Zimmerman, Ferndale, MI (US); Jacqueline Kotenko, Washington, MI (US)

(73) Assignee: Ford Global Technologies, LLC, Dearborn, MI (US)

(21) Appl. No.: 18/989,780

(22) Filed: Dec. 20, 2024

(51) Int. Cl. B25J 15/06; B25J 15/00; B62D 65/02

(52) U.S. Cl. CPC B25J 15/0683; B25J 15/0028; B25J 15/0052; B25J 15/0608; B62D 65/022

(57) ABSTRACT

A robotic gripper apparatus for coupling to a vehicle component includes an end effector that has a frame, at least one gripper, and a first mold. The gripper is mounted to the frame and is configured to grip the first vehicle component. The first mold is mounted to the frame and is configured to align the first vehicle component relative to the first end effector. The first mold is made of an elastomeric material and has a shape corresponding to a shape of the first vehicle component.

### FIELD

The present disclosure relates to a robotic gripper apparatus for coupling to a vehicle component.

### BACKGROUND

The statements in this section merely provide background information related to the present disclosure and may not constitute prior art.

Industrial robots have been used for a variety of manufacturing operations, including by way of example, welding and moving parts from one location to another such as retrieving parts from a storage location and moving them to an assembly station. Automating the moving of some vehicle parts may be challenging because of the lack of proper handling of the part and mechanical repeatability.

These issues related to automating the handling of components, among other issues related to processing the components, are addressed by the present disclosure.

### SUMMARY

This section provides a general summary of the disclosure and is not a comprehensive disclosure of its full scope or all of its features.

In one form, the present disclosure provides a robotic gripper apparatus for coupling to a first vehicle component. The robotic gripper apparatus includes a first end effector that includes a frame, at least one gripper, and a first mold. The gripper is mounted to the frame and is configured to grip the first vehicle component. The first mold is mounted to the frame and is configured to align the first vehicle component relative to the first end effector. The first mold is made of an elastomeric material and has a shape corresponding to a shape of the first vehicle component.

In variations of the robotic gripper apparatus of the above paragraph, which can be implemented individually or in any combination: the gripper is a vacuum gripper; the gripper includes a plurality of grippers mounted to different portions of the frame; the mold is a mesh mold including a plurality of openings; the mold includes a body and end portions, the end portions are tapered inwardly toward the body; the frame includes a main frame and first and second frame members spaced apart from each other and extending from the main frame; the gripper includes a first gripper mounted to the first frame member and a second gripper mounted to the second frame member; the first mold is mounted to the first frame member; and a second mold is mounted to the second frame member and is configured to further align the first vehicle component relative to the first end effector, the second mold has a shape corresponding to the shape of the first vehicle component and has a rigidity that is greater than a rigidity of the first mold; the first end effector further includes a retention feature mounted to one of the first and second frame members and configured to couple a second vehicle component to the first end effector; a second end effector including a pair of opposed grippers moveable between a first position in which the pair of opposed grippers engage a second vehicle component and a second position in which the pair of opposed grippers are disengaged from the second vehicle component; a mounting feature coupled to one of the opposed grippers and configured to grasp the second vehicle component independently of the pair of opposed grippers; the mounting feature includes one or more magnets disposed at least partially therein; and the robotic gripper apparatus further includes a robot arm, the frame coupled to an end of the robot arm.

In one form, the present disclosure provides a robotic gripper apparatus for coupling to a first vehicle component. The robotic gripper apparatus includes a first end effector that includes a frame, a plurality of grippers, and a plurality of molds. The plurality of grippers are mounted to the frame and are configured to grip the first vehicle component. The plurality of molds are mounted to the frame and are configured to align the first vehicle component relative to the first end effector, each mold of the plurality of molds has a shape corresponding to a shape of the first vehicle component. One mold of the plurality of molds has a first rigidity and is a mesh mold with a plurality of openings. Another mold of the plurality of molds is spaced apart from the mold and has a second rigidity that is greater than the first rigidity.

In variations of the robotic gripper apparatus of the above paragraph, which can be implemented individually or in any combination: the plurality of grippers are vacuum grippers; each mold of the plurality of molds includes a body and end portions, the end portions are tapered inwardly toward the body; the frame includes a main frame and first and second frame members spaced apart from each other and extending from the main frame; the plurality of grippers include a first gripper mounted to the first frame member and a second gripper mounted to the second frame member; the one mold is mounted to the first frame member; and the another mold is mounted to the second frame member; the first end effector includes a retention feature mounted to one of the first and second frame members and configured to couple a second vehicle component to the first end effector; a second end effector including a pair of opposed grippers moveable between a first position in which the pair of opposed grippers engage a second vehicle component and a second position in which the pair of opposed grippers are disengaged from the second vehicle component; a mounting feature coupled to one of the opposed grippers and configured to grasp the second vehicle component independently of the pair of opposed grippers; the mounting feature includes one or more magnets disposed at least partially therein; a controller in communication with the second end effector and configured to: instruct the second end effector to grasp the second vehicle component using the pair of opposed grippers, instruct the second end effector to move the second vehicle component to the first end effector and place the second vehicle component on the retention feature; and instruct the second end effector to grasp the second vehicle component using the mounting feature and remove the vehicle component from the retention feature; and the robotic gripper apparatus further includes a robot arm, the frame coupled to an end of the robot arm.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a system for handling a vehicle component of a vehicle according to the principles of the present disclosure;

FIG. 2 is a perspective view of a vehicle body of the vehicle with the vehicle component installed therein;

FIG. 3 is perspective view of a pillar of the vehicle of FIG. 2 including a seat belt;

FIGS. 4A-4E are schematic views showing a first component of the vehicle component being coupled to the vehicle body of FIG. 2;

FIG. 5A is a perspective view of one robot of the system placing a portion of the seat belt onto another robot of the system;

FIG. 5B is a perspective view of one robot of the system of FIG. 1 regripping the portion of the seat belt;

FIG. 5C is a perspective view of one of the robots of the system of FIG. 1 coupling the portion of the seat belt to the vehicle body;

FIGS. 6A-6D are schematic views showing a second component of the vehicle component being coupled to the vehicle body of FIG. 2;

FIG. 7 is a schematic block diagram showing components of the system of FIG. 1 in accordance with the teachings of the present disclosure;

FIG. 8 is a perspective view of an end effector of one of the robots of the system of FIG. 1;

FIG. 9A is a perspective view of an end effector of another robot of the system of FIG. 1 in the closed position;

FIG. 9B is a perspective view of the end effector of FIG. 9A in the open position;

FIG. 10 is a flowchart depicting an algorithm for handling the first component of the system of FIG. 1 in accordance with the teachings of the present disclosure; and

FIG. 11 is a flowchart depicting an algorithm for handling the second component of the system of FIG. 1 in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

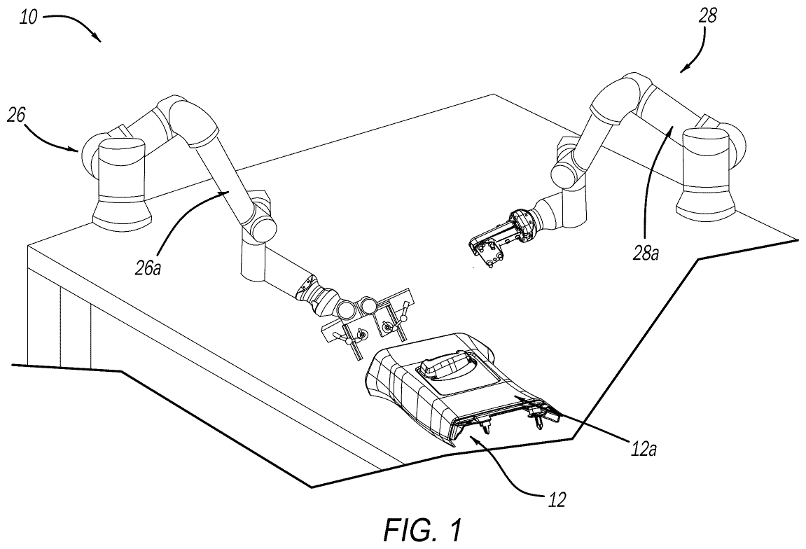

With reference to FIG. 1, a system 10 for handling one or more vehicle components 12 (only one shown in the figure) is illustrated. The handling of the vehicle components 12 may include retrieving the vehicle components 12 from a part support (e.g., a dunnage rack), manipulating parts of the vehicle components 12, and/or installing the vehicle components 12 into a vehicle 17. The system 10 allows for the handling of the vehicle components 12 with little to no human intervention. In this way, the handling of the vehicle components 12 may be automated to increase productivity, reduce cycle time, and reduce variation and error, for example. In the example illustrated, the vehicle components 12 may include vehicle pillar trim components. That is, vehicle pillar components may be challenging to automate due to grasping complex components, protecting surfaces and feeding components through tight spaces. The system 10 of the present disclosure provides for the adaptation of vehicle components 12 such as vehicle pillar components to better support automation. It should be understood that the vehicle components 12 may be other components of a vehicle other than vehicle pillar trim components.

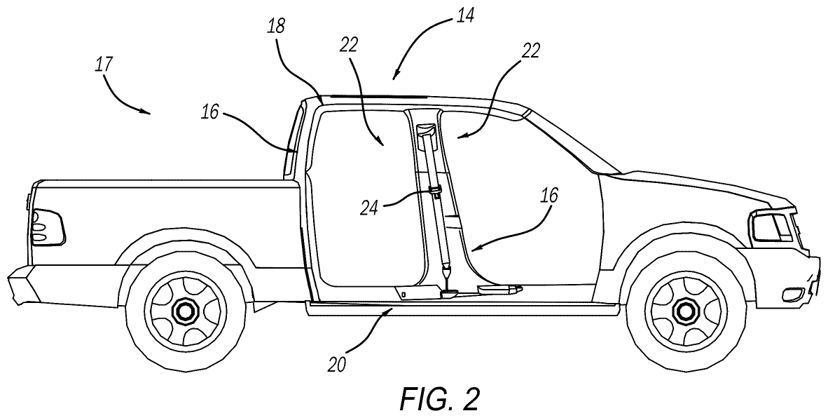

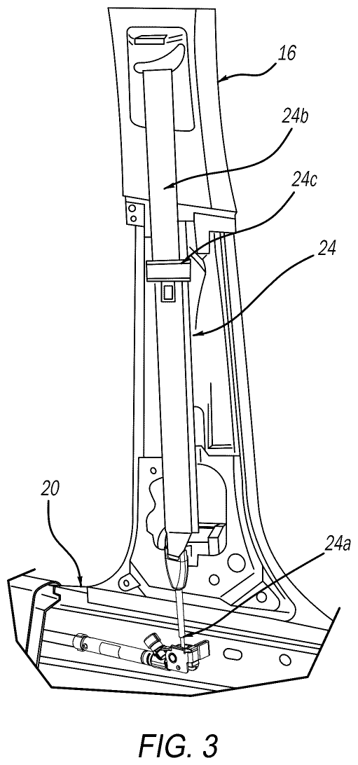

With reference to FIG. 2, the vehicle 17 includes a vehicle body structure 14 having a plurality of pillars 16, a pair of side rails 18 (only one shown in the figure), and rockers 20 (only one shown in the figure). The pillars 16, the rockers 20 and the side rails 18 cooperate to define door openings 22 in the vehicle body structure 14. Doors (not shown) are rotatably coupled to the vehicle body structure 14 between a closed position in which the doors are disposed within the door openings 22 and an open position in which the doors are removed from the door openings 22. With additional reference to FIG. 3, seat belts 24 are coupled to the vehicle 17 (e.g., a pillar 16 of the vehicle 17) and each may include, inter alia, a pretensioner 24a, a webbing 24b, and a tongue 24c. The pretensioner 24a may permit the webbing 24b to fit snug against the occupant's body. The tongue 24c is coupled to the webbing 24b and fits into a buckle (not shown) to secure the seat belt 24.

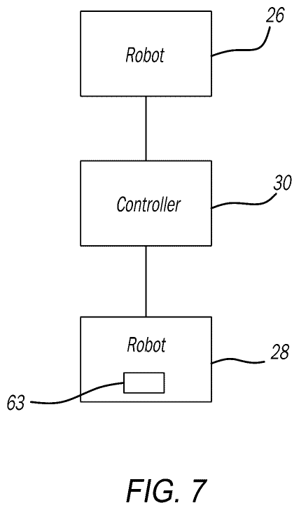

With reference back to FIG. 1, the system 10 includes robots 26, 28, the vehicle component 12, and a controller 30 (FIG. 7). As will be described in more detail below, the robot 26 is configured to pick-up parts of the vehicle component 12, move parts of the vehicle component 12 from a work surface, for example, to the vehicle 17, manipulate (e.g., rotate) parts of the vehicle component 12 relative to the vehicle 17, and couple parts of the vehicle component 12 to the vehicle 17. The robot 26 includes a robot arm 26a and a robotic gripper structure or end effector 26b. The robot arm 26a includes a plurality of segments connected to each other at joints, thereby allowing the robot 26 to have multiple degrees of freedom. The robot arm 26a is also secured to the work surface at a first end. In some variations, the robot arm 26a includes an optional adapter (not shown) that is adapted to be secured to the work surface. In some forms, the robot 26 is separate from the work surface and is partially or fully autonomous and is configured to autonomously move to the part support (not shown) and/or work surface as instructed by the controller 30. To autonomously move itself, the controller 30 is configured to control various movement systems of the robot 26 based on location data obtained from one or more sensors. In an example application, the movement systems may include propulsion systems, and/or steering systems for controlling wheels, and the sensors for providing location data may include a GNSS sensor, an imaging sensor, a local position sensor, among others.

The robotic gripper structure 26b is secured to the robot arm 26a and is configured to pick-up the parts of the vehicle component 12. In this way, the robotic gripper structure 26b may grip the parts of the vehicle component 12 and move the parts from one location to another location as will be described in more detail below. The robotic gripper structure 26b may also manipulate the parts (e.g., rotate the parts) relative to the vehicle 17 to facilitate coupling the parts of the vehicle component 12 to the vehicle 17.

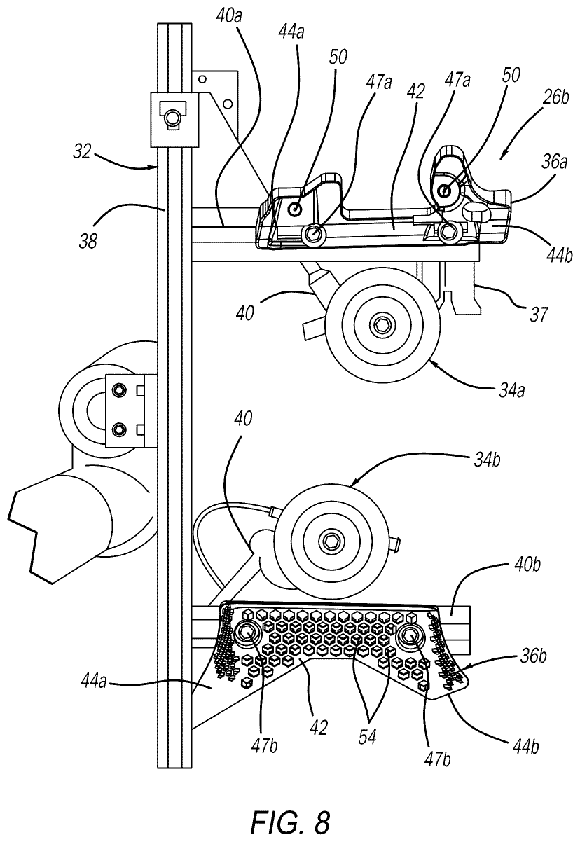

With reference to FIG. 8, the robotic gripper structure 26b includes a frame 32, one or more grippers 34a, 34b, one or more molds 36a 36b, and a retention feature 37. The frame 32 is coupled to an end of the robot arm 26a and supports the grippers 34a, 34b and the molds 36a, 36b. The frame 32 includes a main frame 38 and frame members 40a, 40b. In the example illustrated, the main frame 38 has a length that is greater than lengths of the frame members 40a, 40b. In some forms, each of the frame members 40a, 40b may have a length that is equal to or greater than the length of the main frame 38. In the example illustrated, the frame member 40a extends from the main frame 38 at or near a first end and the frame member 40b extends from the main frame 38 at or near a second end that is opposite the first end (i.e., the first and second frame members 40a, 40b are spaced apart from each other). In the example illustrated, the first and second frame member 40a, 40b extend perpendicularly from the main frame 38. In other variations, the first and second frame members 40a, 40b may extend from the main frame 38 at a non-perpendicular angle (e.g., obtuse angle or acute angle). In the example illustrated, the main frame 38 and the first and second frame members 40a, 40b are combined to form a unitized structure. In some forms, the frame 32 may be manufactured using an injection molding process, for example, such that the frame 32 is a unitary, monolithic part.

The grippers 34a, 34b are mounted to the frame 32 and are configured to grip the vehicle component 12. In the example illustrated, the grippers 34a, 34b are vacuum suction grippers or suction cup grippers that grip or lift the vehicle component 12 using suction. In the example illustrated, each gripper 34a, 34b is mounted to the frame 32 using an attachment mechanism 40. In some forms, each gripper 34a, 34b may be mounted to the frame 32 at a predetermined position to facilitate lifting or gripping the vehicle component 12. That is, the gripper 34a may be mounted to the frame member 40a and the gripper 34b may be mounted to the frame member 40b. In the example illustrated, the grippers 34a, 34b are located between the molds 36a, 36b. In some forms, the molds 36a, 36b may be located between the grippers 34a, 34b. In some forms, the robotic gripper structure 26b may include additional grippers (not shown) mounted to the main frame 38 or other parts of the frame 32 to further facilitate lifting or gripping of the vehicle component 12. It should be understood that the grippers 34a, 34b may grip or pick-up parts independently of each other as well as together.

The molds 36a,36b are mounted to the frame 32 and are configured to align the vehicle component 12 relative to the end effector 26b prior to the end effector gripping or lifting the vehicle component 12. Each mold 36a, 36b has a shape that corresponds to a shape (e.g., an outer profile) of the vehicle component 12 and includes a body 42, and end portions 44a, 44b. The end portions 44a, 44b are tapered inwardly toward the body 42. Stated differently, contact surfaces (surfaces of molds 36a, 36b that come in contact with vehicle component 12) of the end portions 44a, 44b are tapered inwardly toward the body 42. In this way, alignment of the vehicle component 12 relative to the end effector 26b is facilitated. In the example illustrated, the mold 36a is mounted to the frame member 40a via fasteners 47a (e.g., screws, bolts, rivets) and the mold 36b is mounted to the frame member 40b via fasteners 47b (e.g., screws, bolts, rivets). That is, the fasteners 47a may extend through the body 42 of the mold 36a and the frame member 40a to couple the mold 36a to the frame member 40a, and the fasteners 47b may extend through the body 42 of the mold 36b and the frame member 40b to couple the mold 36b to the frame member 40b. In some forms, additional molds (not shown) may be attached the frame 32 to further facilitate alignment of the vehicle component 12 relative to the end effector 26b. Each mold 36a, 36b has a length that extends parallel to a length of the frame member 40a, 40b.

In the example illustrated, the mold 36a may have a rigidity that is greater than a rigidity of the mold 36b. Stated differently, the mold 36a may have a stiffness that is greater than a stiffness of the mold 36b. In this way, the mold 36a is less likely to be forced out of shape than the mold 36b. The mold 36a has a recess that is configured to receive a portion of the vehicle component 12. The mold 36a also includes one or more protrusions 50 extending therefrom and configured to be received in grooves of the vehicle component 12. In this way, the vehicle component 12 is further aligned with the end effector 26b. The protrusions 50 are spaced apart from each other and extend downward beyond a surface of the mold 36a (the protrusions 50 extend into the recess. The protrusions 50 may extend downward from the body 42 and/or the end portions 44a, 44b of the mold 36a.

The mold 36b may be made of a softer material than the mold 36a. For example, the mold 36b may be made of a rubber material such as a thermoplastic polyurethane (TPU) and the mold 36a may be made of a plastic. In this way, the mold 36b may contact class-A surfaces (occupant facing surfaces) of the vehicle component 12 during the assembly process without distorting the surfaces. In the example illustrated, the mold 36b is a mesh mold including a plurality of openings 54. Stated differently, the openings 54 may be formed in the body 42 of the mold 36b and the end portions 44a, 44b of the mold 36b. In this way, the mold 36b includes a complaint geometry to further inhibit distorting of the surfaces of the vehicle component 12 during the assembly process. The mold 36b has a recess that is configured to receive a portion of the vehicle component 12.

The retention feature 37 is mounted to one of the frame members 40a, 40b and is configured to removably couple a portion (e.g., the pretensioner 24a) of the seat belt 24 thereto as will be described in more detail below. In the example illustrated, the retention feature 37 is coupled to the frame member 40a. In some forms, the retention feature 37 may be coupled to the frame member 40b. The retention feature 37 may define a slot that temporarily receives the portion of the seat belt 24.

The robot 28 is configured to pick-up parts of the seat belt 24, guide or direct parts of the seat belt 24 through the vehicle component 12, manipulate (e.g., rotates) parts of the seat belt 24 relative to the vehicle 17 and/or the vehicle component 12, and couple parts of the seat belt 24 to the vehicle 17. The robot 28 includes a robot arm 28a and a robotic gripper structure or end effector 28b. The robot arm 28a includes a plurality of segments connected to each other at joints, thereby allowing the robot 28 to have multiple degrees of freedom. The robot arm 28a is also secured to the work surface at a first end. In some variations, the robot arm 28a includes an optional adapter (not shown) that is adapted to be secured to the work surface. In some forms, the robot 28 is separate from the work surface and is partially or fully autonomous and is configured to autonomously move to the part support (not shown) and/or work surface as instructed by the controller 30. To autonomously move itself, the controller 30 is configured to control various movement systems of the robot 28 based on location data obtained from one or more sensors. In an example application, the movement systems may include propulsion systems, steering systems for controlling wheels, and the sensors for providing location data may include a GNSS sensor, an imaging sensor, a local position sensor, among others.

The robotic gripper structure 28b is secured to the robot arm 28a and is configured to pick-up the parts of the seat belt 24. In this way, the robotic gripper structure 28b may grip the parts of the seat belt 24 and guide the parts through the vehicle component 12 as will be described in more detail below. The robotic gripper structure 28b may also manipulate the parts (e.g., rotate the parts) relative to the vehicle 17.

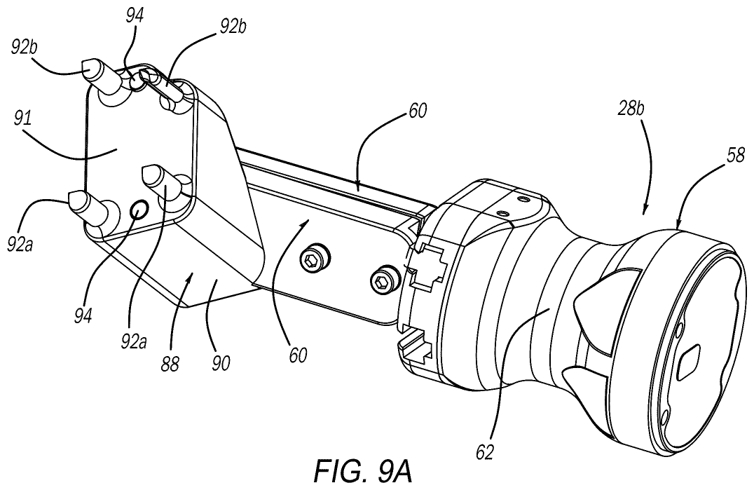

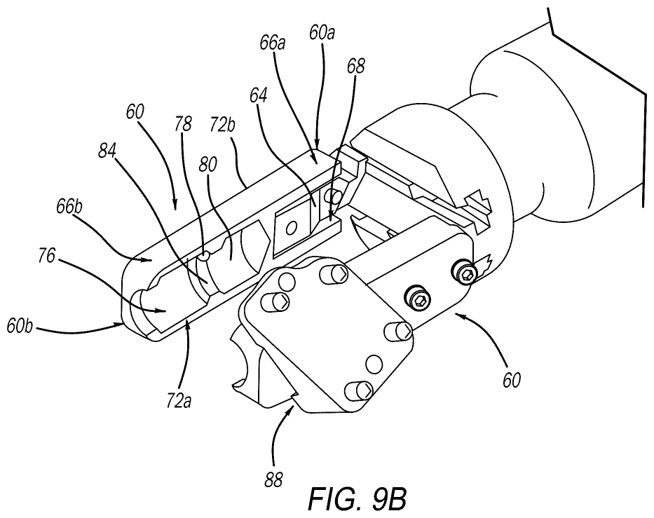

With reference to FIGS. 9A and 9B, the robotic gripper structure 28b includes an actuator assembly 58 and a pair of opposed grippers 60. The actuator assembly 58 is secured to a second end of the robot arm 28a. The actuator assembly 58 includes a body 62, a motor 63 (FIG. 7), and a pair of movable members or arms 64. The body 62 is secured to the second end of the robot arm 28a. The motor 63 is associated with the body 62 (e.g., disposed within the body 62) and is in electrical communication with the controller 30. The controller 30 may be in communication with the motor 63 via, for example, an internet, Wi-Fi, Bluetooth®, Zigbee®, power-line carrier communication (PLCC), or cellular connection or any other wired or wireless communication protocol. The motor 63 is operable between an OFF mode and an ON mode. In one form, the motor 63 may be an electric motor such as a brushless drive motor. Each arm 64 is operatively connected to the motor 63 via a respective rail or connecting member (not shown) and is allowed to move in a transverse direction (i.e., transverse to a longitudinal direction of the arm 64). For example, when the motor 63 is in the OFF mode, the arms 64 are inhibited from moving in the transverse direction. When the motor 63 is in the ON mode, the arms 64 are allowed to move in the transverse direction between an open state and a closed state.

The pair of grippers 60 are secured to respective arms 64 and are movable in a transverse direction between a first position in which the pair of opposed grippers 60 engage a portion or part (e.g., the pretensioner 24a) of the seat belt 24 and a second position in which the pair of opposed grippers 60 are disengaged from the portion of the seat belt 24. Stated differently, each gripper 60 is secured to the respective arm 64 such that when the respective arm 64 is moved to the closed state, the gripper 60 is moved to the closed position (FIG. 9A), and when the respective arm 64 is in the open state, the gripper 60 is in the open position (FIG. 9B).

In the example illustrated, each gripper 60 includes an attachment portion 66a and an engaging portion 66b. The attachment portion 66a is located near or at a first end 60a of the gripper 60 and includes a recess 68 and a plurality of openings (not specifically shown). The recess 68 may be formed on an inner side 72a of the gripper 60 and may receive a portion of a respective arm 64. The openings may be spaced apart from each other and may extend from an outer side 72b of the gripper 60 to the recess 68 formed on the inner side 72a of the gripper 60. In this way, mechanical fasteners (not shown) may extend through the respective arm 64 and the openings, thereby securing the respective arm 64 and the gripper 60 to each other.

The engaging portion 66b is located near or at a second end 60b of the gripper 60 and includes a mounting feature 76 that is configured to engage with a part of the seat belt 24. In the example illustrated, the mounting feature 76 is a groove formed in the engaging portion 66b of the gripper 60 and opening through the second end 60b of the gripper 60. A bump feature 78 may extend from an arcuate surface 80 of the groove and may be received in an aperture of the part of the seat belt 24. In this way, movement between the grippers 60 and the part of the seat belt 24 is inhibited when the grippers 60 engage the portion of the seat belt 24 in the closed position. A semi-circular shaped lip 84 extends outward from the arcuate surface 80 of the groove and may be received in a slot of the part of the seat belt 24. In this way, axial movement between the grippers 60 and the part of the seat belt 24 is inhibited when the grippers 60 engage the portion of the seat belt 24 in the closed position.

A mounting feature 88 is coupled to one of the grippers 60 and is configured to grasp the part (the pretensioner 24a) of the seat belt 24 independently of the pair of opposed grippers 60. In the example illustrated, the mounting feature 88 includes a body 90 and a plurality of pairs of fingers 92a, 92b extending from a surface 91 of the body 90. The first pair of fingers 92a may be spaced apart from each other and the second pair of fingers 92b may be spaced apart from each other. In this way, the part of the seat belt 24 may be disposed between the pairs of fingers 92a, 92b. One or more permanent magnets 94 such as rare earth magnets may be disposed within the body 90 and may be exposed at the surface 91 of the body 90. In this way, when the part of the seat belt 24 is disposed between the pairs of fingers 92a, 92b, the magnets 94 are attracted to the part of the seat belt 24. That is, the permanent magnet 94 produces a magnetic force that is attracted to the metallic part of the seat belt 24. In this way, the magnets 94 and the metallic part of the seat belt 24 are magnetically coupled to each other, thereby further coupling the part of the seat belt 24 to the mounting feature 88. It should be understood that the grippers 60 and the mounting feature 88 may be allowed to grip different portions of the part of the seat belt 24. That is, the grippers 60 may grip an end (e.g., axial end) of the part of the seat belt 24 while the mounting feature 88 may grip an area between the ends of the part of the seat belt 24 (i.e., around a cylindrical surface). In the example illustrated, the gripper 60 may be manufactured (e.g., injection molded) to include the mounting feature 88. In some forms, the mounting feature 88 may be a separate component that is coupled to the gripper 60, thereby forming a unitized structure.

The robot 28 may also optionally include vision sensors that collect visual image data and transmits the data to the controller 30. Based on the visual image data, the controller 30 provides instructions to the robot 28 to operate the robot 28. More specifically, the controller 30 provides instructions to operate the robot 28 to grasp and move the part of the seat belt 24. One example of such vision sensor is disclosed in U.S. patent application Ser. No. XX/000,000, and titled “SYSTEM FOR HANDLING ELECTRICAL COMPONENTS FOR VEHICLE,” which is commonly owned with the present application and the contents of which are incorporated herein by reference in its entirety.

With reference to FIG. 7, the controller 30 is in communication with the robots 26, 28 and may monitor and control operations of the robots 26, 28 based on data received. In one example, the controller 30 is in communication with the robots 26, 28 using a wired or wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others). The robots 26, 28 and the controller 30 form a robotic gripper apparatus.

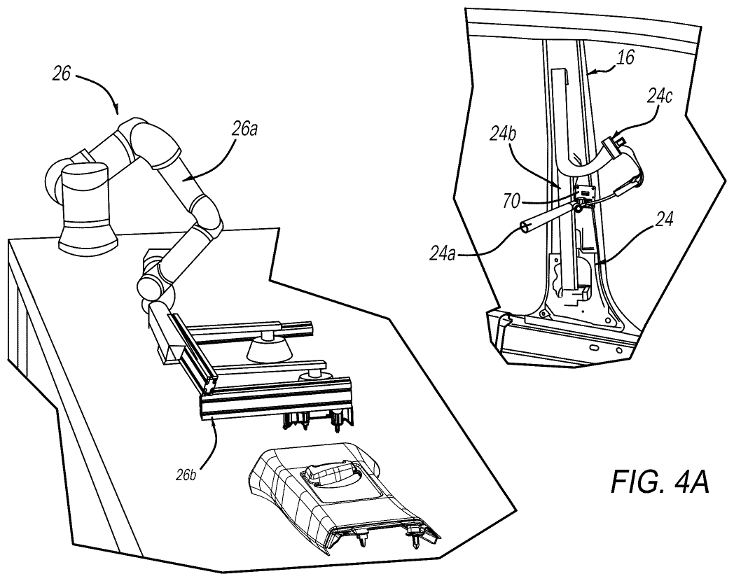

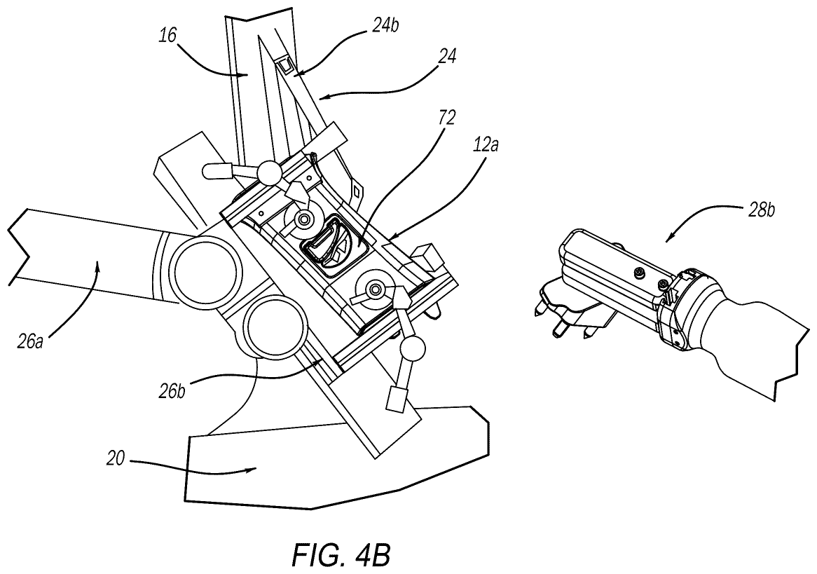

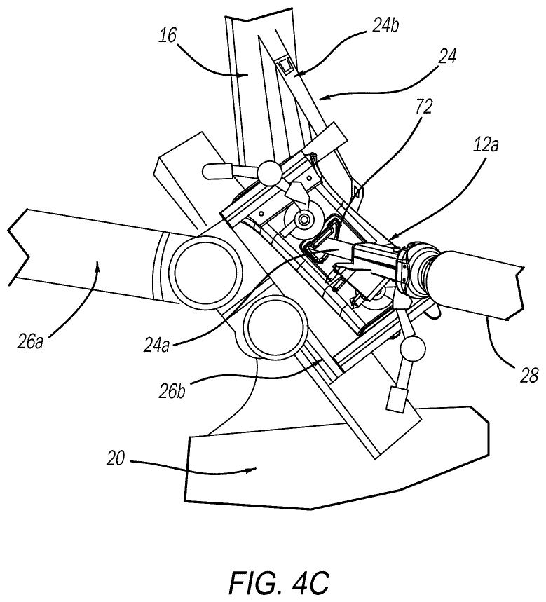

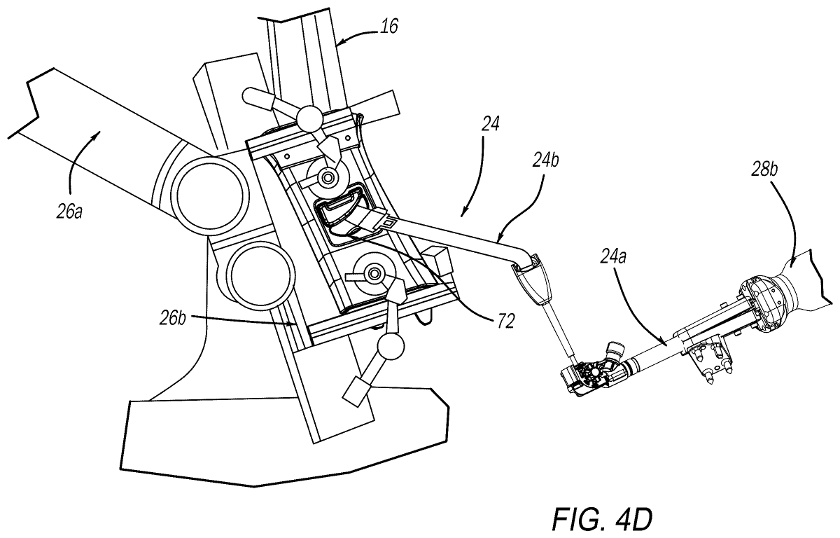

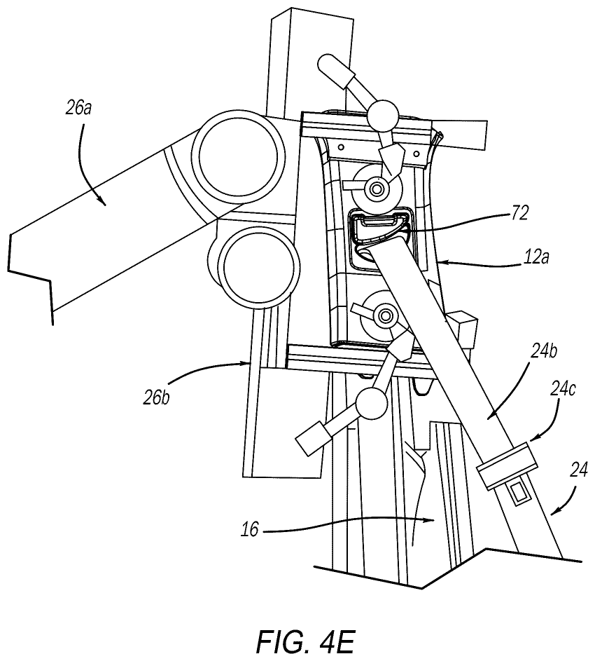

Referring to FIGS. 4A-4E and 9, an example control algorithm 200 for assembling a trim panel or first vehicle component 12a of the vehicle component 12 into the vehicle 17 is illustrated. The processing may begin once the first vehicle component 12a is moved from the part support (not shown) to the work surface and/or the vehicle body structure 14 arrives at a workstation where the first vehicle component 12a and the robots 26, 28 are located. At 204, the control algorithm, using the controller 30, instructs the robot 26 to grip or pick-up the first vehicle component 12a of the vehicle component 12 (FIG. 4A) using the end effector 26b. The first vehicle component 12a may be located at a rack or storage area that inhibits movement of the first vehicle component 12a prior to being picked-up by the robot 26. At 208, the control algorithm, using the controller 30, instructs the robot 26 to move the first vehicle component 12a to the vehicle pillar 16 of the vehicle body structure 14 such that an opening 72 of the first vehicle component 12a receives a portion of the pretensioner 24a (FIG. 4B; i.e., the pretensioner 24a is received at least partially through the opening 72 of the first vehicle component 12a). In some forms, the robot 26 may move the first vehicle component 12a to the vehicle pillar 16 such that the pretensioner 24a is located at the opening 72 of the first vehicle component 12a without being partially received in the opening 72 of the first vehicle component 12a.

At 212, the control algorithm, using the controller 30, instructs the robot 28 to grip the pretensioner 24a using the end effector 28b and guide the pretensioner 24a, the tongue 24c and a portion of the webbing 24b through the opening 72 of the first vehicle component 12a (FIGS. 4C and 4D). The robot 26 may move the first vehicle component 12a and/or the robot 28 may move (e.g., rotate) the pretensioner 24a to reposition the first vehicle component 12a relative to the second robot 28 in order to facilitate insertion of the pretensioner 24a, the tongue 24c and the portion of the webbing 24b through the opening 72 of the first vehicle component 12a. For example, the pretensioner 24a may be rotated, then guided through the opening 72 of the first vehicle component 12a before repositioning the first vehicle component 12a in order to guide the tongue 24c through the opening 72. It should be understood that the pretensioner 24a is temporarily located on the pillar 16 of the vehicle body structure 14. That is, in the example illustrated, a bracket 70 (FIG. 4A) may be secured to the pillar 16 and the pretensioner 24a may be removably coupled to the bracket 70. In this way, the robot 28 may detach the pretensioner 24a from the bracket 70 to guide the pretensioner 24a through the opening 72 of the first vehicle component 12a as described above. It should also be understood that the tongue 24c is temporarily retained in a set position on the webbing 24b during the process using a retention feature such as an elastic material, a clip or any other suitable retention feature. The retention feature may be removed from the tongue 24c once the vehicle component 12 is coupled to the pillar 16, thereby allowing the tongue to move along the webbing 24b.

At 216, the control algorithm, using the controller 30, instructs the robot 26 to couple the first vehicle component 12a to the vehicle pillar 16 of the vehicle body structure 14 (FIG. 4E). In the example illustrated, the first vehicle component 12a is coupled to an upper portion of the vehicle pillar 16 by snap fit, fasteners, or any other suitable attachment method. In some forms, the first vehicle component 12a may be coupled to a middle or another location of the vehicle pillar 16.

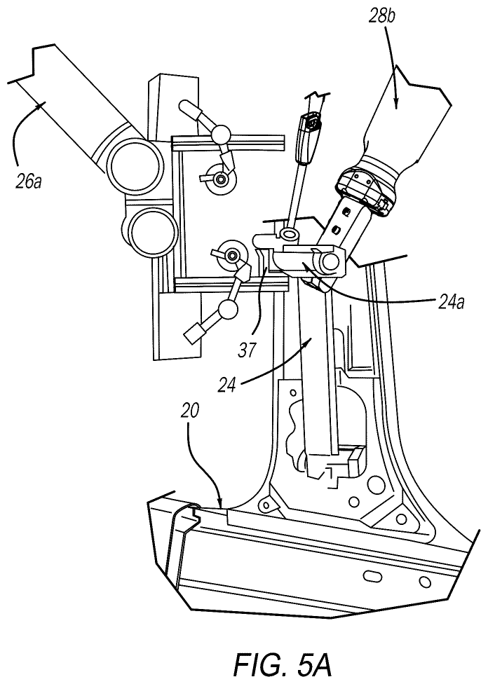

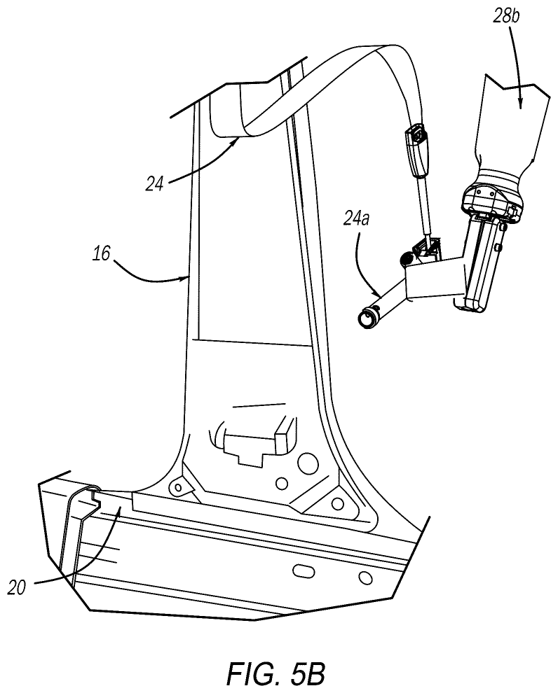

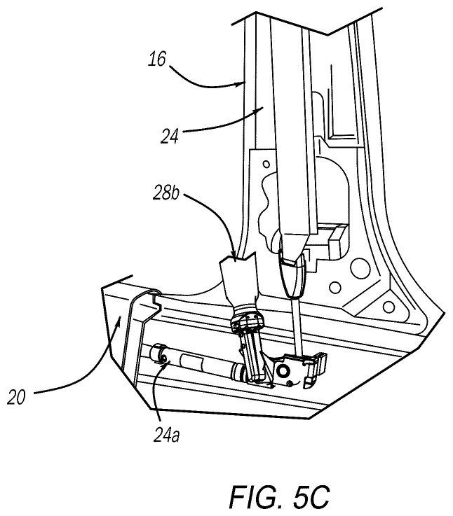

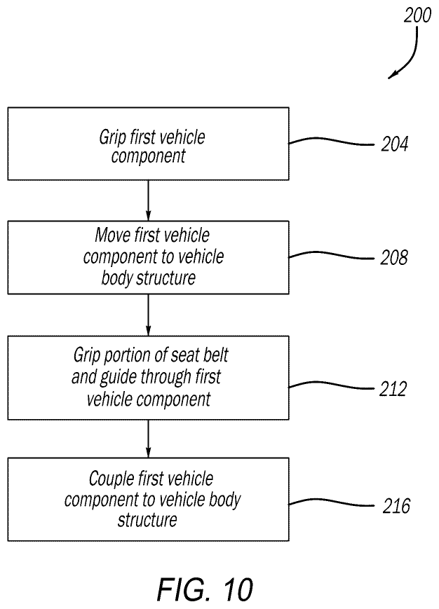

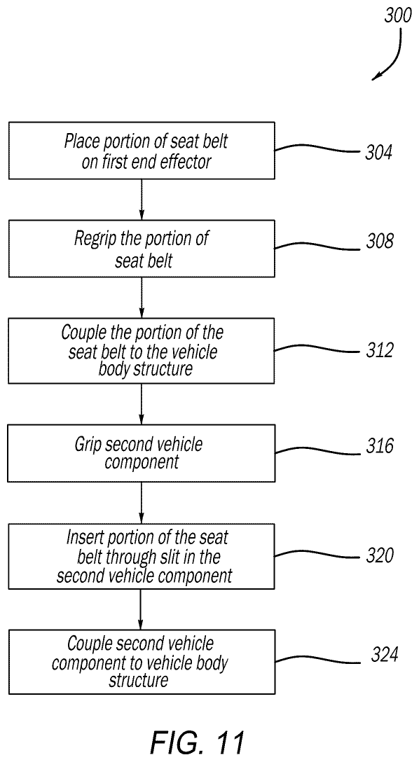

Referring to FIGS. 5A-5C, 6A-6D and 10, an example control algorithm 300 for assembling a trim panel or second vehicle component 12b of the vehicle component 12 into the vehicle 17 is illustrated. The processing may begin once the first vehicle component 12a is coupled to the vehicle pillar 16. At 304, the control algorithm, using the controller 30, instructs, the robot 28 to place a portion of the seat belt 24 (e.g., the pretensioner 24a) on the retention feature 37 of the end effector 26b (FIG. 5A). In this way, the portion of the seat belt 24 is supported by the end effector 26b. At 308, the control algorithm, using the controller 30, instructs the robot 28 to regrip the pretensioner 24a (FIG. 5B) using the mounting feature 88. That is, the robot 28 places the pretensioner 24a on the retaining feature 37 of the end effector 26b in order to regrip the pretensioner 24a at another location. Stated differently, the robot 28 initially grips an end portion of the pretensioner 24a (e.g., axial end) using the grippers 60 before regripping a middle portion of the pretensioner 24a using the mounting feature 88. At 312, the control algorithm, using the controller 30, instructs the robot 28 to couple the pretensioner 24a to the vehicle body structure 14 (FIG. 5C). That is, the robot 28 may couple the pretensioner 24a to a rocker of the vehicle body structure 14 via fasteners (e.g., bolts, screws, rivets). In some forms, another robot (not shown) may assist in coupling the pretensioner 24a to the vehicle body structure 14 or the pretensioner 24a may be manually coupled to the vehicle body structure 14 via the fasteners.

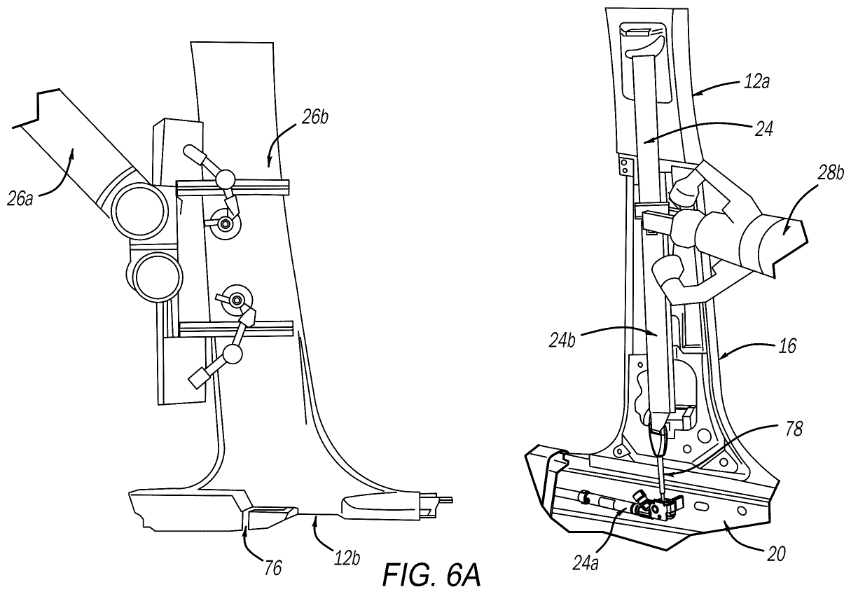

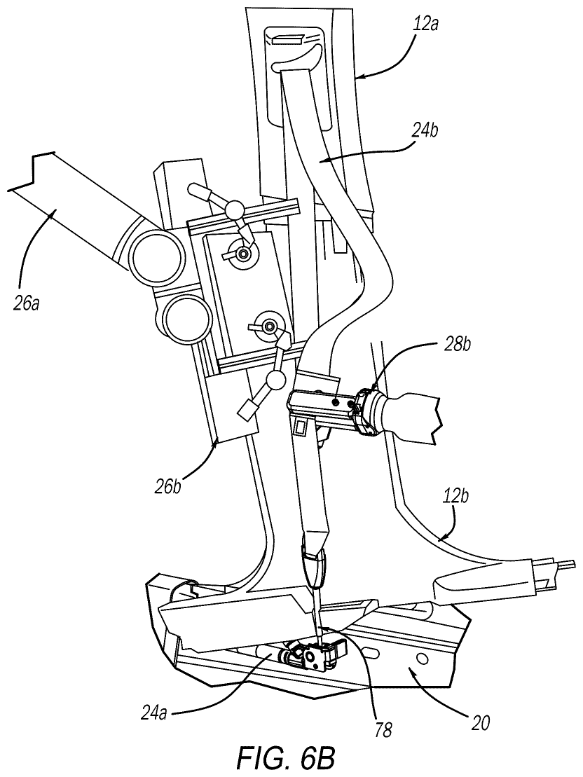

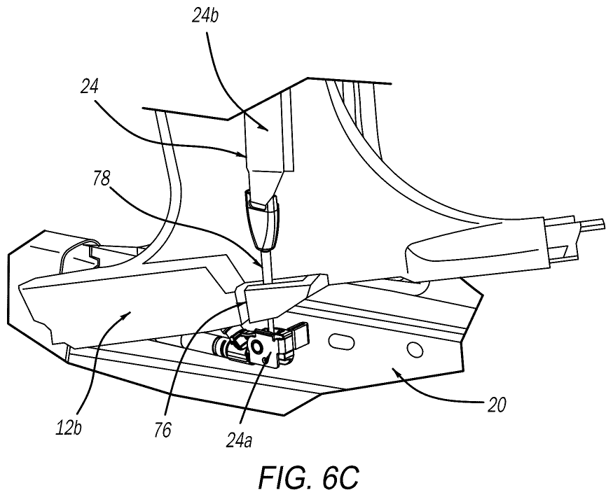

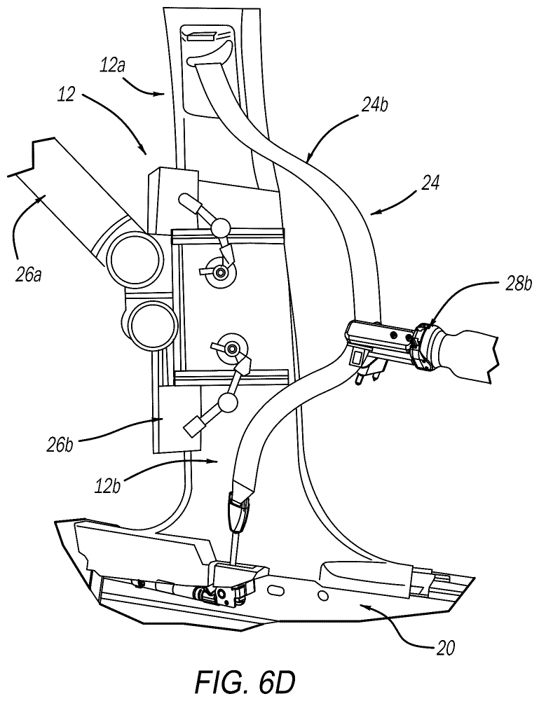

At 316, the control algorithm, using the controller 30, instructs the robot 26 to grip or pick-up the second vehicle component 12b of the vehicle component 12 using the end effector 26b. The second vehicle component 12b may be located at a rack or storage area that inhibits movement of the second vehicle component 12b prior to being picked-up by the robot 26. At 320, the control algorithm, using the controller 30, instructs the robot 26 to move the second vehicle component 12b in a desired pattern such that a portion 78 (e.g., rigid anchor) of the seat belt 24 is received in an opening or slit 76 (slit 76 is exaggerated in figures for clarity) in the second vehicle component 12b. That is, movement of the second vehicle component 12b guides the portion 78 of the seat belt 24 through the opening in a lower portion of the second vehicle component 12b (FIGS. 6B and 6C). The opening 76 in the lower portion of the second vehicle component 12b may be arcuate or extend in multiple directions such that a first end of the opening 76 opens through a first side of the second vehicle component 12b and a second end of the opening 76 is located between the first side and a second side of the second vehicle component 12b. Once the portion of the seat belt 24 is disposed at or near the second end of the opening 76, the second vehicle component 12b and the seat belt 24 are coupled to each other. It should be understood that as the robot 26 is guiding the portion 78 of the seat belt 24 through the opening 76, the robot 28 may grip or grasp the webbing 24b of the seat belt 24 and pull the webbing 24b away from the second vehicle component 12b. In this way, entanglement between the second vehicle component 12b and the webbing 24b is inhibited.

At 324, the control algorithm, using the controller 30, instructs the robot 26 to couple the second vehicle component 12b to the vehicle pillar 16 of the vehicle body structure 14 (FIG. 6D). In the example illustrated, the second vehicle component 12b is coupled to a lower portion of the vehicle pillar 16 by snap fit, fasteners, or any other suitable attachment method. In some forms, the second vehicle component 12b may be coupled to a middle or another location of the vehicle pillar 16. In some forms, coupling the second vehicle component 12b to the vehicle pillar 16 includes coupling the second vehicle component 12b to the first vehicle component 12a.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A robotic gripper apparatus for coupling to a first vehicle component, the robotic gripper apparatus comprising:
a first end effector comprising:
a frame;
at least one gripper mounted to the frame and configured to grip the first vehicle component; and
a first mold mounted to the frame and configured to align the first vehicle component relative to the first end effector, the first mold made of an elastomeric material and having a shape corresponding to a shape of the first vehicle component.

2. The robotic gripper apparatus of claim 1, wherein the at least one gripper is a vacuum gripper.

3. The robotic gripper apparatus of claim 1, wherein the at least one gripper includes a plurality of grippers mounted to different portions of the frame.

4. The robotic gripper apparatus of claim 1, wherein the at least one mold is a mesh mold including a plurality of openings.

5. The robotic gripper apparatus of claim 1, wherein the at least one mold includes a body and end portions, and wherein the end portions are tapered inwardly toward the body.

6. The robotic gripper apparatus of claim 1, wherein:
the frame includes a main frame and first and second frame members spaced apart from each other and extending from the main frame;
the at least one gripper includes a first gripper mounted to the first frame member and a second gripper mounted to the second frame member;
the first mold mounted to the first frame member; and
a second mold mounted to the second frame member and configured to further align the first vehicle component relative to the first end effector, the second mold having a shape corresponding to the shape of the first vehicle component and having a rigidity that is greater than a rigidity of the first mold.

7. The robotic gripper apparatus of claim 6, further comprising a retention feature mounted to one of the first and second frame members and configured to couple a second vehicle component to the first end effector.

8. The robotic gripper apparatus of claim 6, further comprising:
a second end effector comprising:
a pair of opposed grippers moveable between a first position in which the pair of opposed grippers engage a second vehicle component and a second position in which the pair of opposed grippers are disengaged from the second vehicle component; and
a mounting feature coupled to one of the opposed grippers and configured to grasp the second vehicle component independently of the pair of opposed grippers.

9. The robotic gripper apparatus of claim 8, wherein the mounting feature includes one or more magnets disposed at least partially therein.

10. The robotic gripper apparatus of claim 1, further comprising:
a second end effector comprising:
a pair of opposed grippers moveable between a first position in which the pair of opposed grippers engage a second vehicle component and a second position in which the pair of opposed grippers are disengaged from the second vehicle component; and
a mounting feature coupled to one of the opposed grippers and configured to grasp the second vehicle component independently of the pair of opposed grippers.

11. The robotic gripper apparatus of claim 1, further comprising a robot arm, the frame coupled to an end of the robot arm.

12. A robotic gripper apparatus for coupling to a first vehicle component, the robotic gripper apparatus comprising:
a first end effector comprising:
a frame;
a plurality of grippers mounted to the frame and configured to grip the first vehicle component; and
a plurality of molds mounted to the frame and configured to align the first vehicle component relative to the first end effector, each mold of the plurality of molds has a shape corresponding to a shape of the first vehicle component, one mold of the plurality of molds has a first rigidity and is a mesh mold with a plurality of openings, another mold of the plurality of molds is spaced apart from the one mold and has a second rigidity that is greater than the first rigidity.

13. The robotic gripper apparatus of claim 12, wherein the plurality of grippers are vacuum grippers.

14. The robotic gripper apparatus of claim 12, wherein each mold of the plurality of molds includes a body and end portions, and wherein the end portions are tapered inwardly toward the body.

15. The robotic gripper apparatus of claim 12, wherein:
the frame includes a main frame and first and second frame members spaced apart from each other and extending from the main frame;
the plurality of grippers include a first gripper mounted to the first frame member and a second gripper mounted to the second frame member;
the one mold mounted to the first frame member; and
the another mold mounted to the second frame member.

16. The robotic gripper apparatus of claim 15, further comprising a retention feature mounted to one of the first and second frame members and configured to couple a second vehicle component to the first end effector.

17. The robotic gripper apparatus of claim 15, further comprising:
a second end effector comprising:
a pair of opposed grippers moveable between a first position in which the pair of opposed grippers engage a second vehicle component and a second position in which the pair of opposed grippers are disengaged from the second vehicle component; and
a mounting feature coupled to one of the opposed grippers and configured to grasp the second vehicle component independently of the pair of opposed grippers.

18. The robotic gripper apparatus of claim 17, wherein the mounting feature includes one or more magnets disposed at least partially therein.

19. The robotic gripper apparatus of claim 17, further comprising:
a controller in communication with the second end effector and configured to:
instruct the second end effector to grasp the second vehicle component using the pair of opposed grippers;
instruct the second end effector to move the second vehicle component to the first end effector and place the second vehicle component on the retention feature; and
instruct the second end effector to grasp the second vehicle component using the mounting feature and remove the vehicle component from the retention feature.

20. The robotic gripper apparatus of claim 12, further comprising a robot arm, the frame coupled to an end of the robot arm.
